(19) United States
(12) Patent Application Publication
(10) Pub. No.: US 2020/0048146 A1
(43) Pub. Date: Feb. 13, 2020

(54) LIME KILN APPARATUS FULLY RECYCLING CO2

(71) Applicant: Shiheng Zhang, Beiging (CN)

(72) Inventors: Changchun WANG, beijing (CN); Shiheng ZHANG, beijing (CN); Xiaolong WANG, beijing (CN); Wenqing AO, beijing (CN); Xi JIANG, beijing (CN); Bing JIA, beijing (CN)

(21) Appl. No.: 16/595,514

(22) Filed: Oct. 8, 2019

Related U.S. Application Data
(63) Continuation-in-part of application No. PCT/CN2018/000062, filed on Feb. 5, 2018.

(30) Foreign Application Priority Data
Apr. 17, 2017 (CN) 201710247979.6

(51) Int. Cl. C04B 2/12; B01D 53/14

(52) U.S. Cl. CPC C04B 2/12; B01D 53/1418

(57) ABSTRACT

The present application provides a lime kiln apparatus recycling CO₂ which includes a kiln body (100) and a heat-accumulating furnace set (20). The kiln body (100) defines no burner therein, and the heat-accumulating furnace set (20) provides hot CO₂ (70) heated to a set temperature to the kiln body (100) for calcining mineral material, thereby finished lime is obtained. CO₂ generated during the lime production is all recycled. After being dedusted, a part of the recycled CO₂ is transported to the heat-accumulating furnace set (20) for heating, and is sent back to the kiln for calcining the mineral material after being heated to a temperature within a range of 800° C.-1200° C., and the other part of the recycled CO₂ is recycled for use.

### CROSS REFERENCE TO RELATED APPLICATION

The present disclosure is a Continuation-in-part application of the International application No. PCT/CN2018/000062 filed Feb. 5, 2018, which further claimed the Chinese patent application No. 201710247979.6, entitled “LIME KILN APPARATUS FULLY RECYCLING CO₂”, filed Apr. 17, 2017, the entire content of which are hereby incorporated by reference.

### TECHNICAL FIELD

The present application relates to a technical field of lime kiln apparatus, and in particular, relates to a lime kiln apparatus using gas fuel and a method for producing lime by using the lime kiln.

### BACKGROUND

Lime, namely calcium oxide (CaO), has been widely used as one of vital raw materials in industries including steel, calcium carbide, alumina, and refractory materials. For example, 70 kilograms of lime are required for every ton of steel in the metallurgical industry. As the main raw material for preparing lime, limestone is mainly made up of calcium carbonate (CaCO₃). The basic mechanism for preparing lime is to decompose the calcium carbonate in limestone into calcium oxide and carbon dioxide by means of heating, as shown in the reaction formula: CaCO₃=CaO+CO₂ (in which 42.5 Kcal heat is called for reaction).

The process for preparing lime may be mainly divided into four steps: preheating, calcining, cooling and discharging. Specifically, the current preparing method includes the following operations of: loading limestone and solid fuel into a lime kiln, or feeding gas fuel through a pipeline and a burner into the kiln body for combustion while the limestone is loaded into the lime kiln; heating the limestone to a decomposition—starting temperature of 800° C. to 850° C., until the limestone being calcined at 1200° C. to obtain lime; cooling the obtained lime before discharging them. In the current method, one ton lime will produce more than one ton of CO₂ emission. CO₂ plays a key part in various departments concerning domestic economy, such as industries of food, health, petrochemistry, nuclear, fire fighting, and metallurgy, but recycling it would be expensive from fuel gas including 10%-15% CO₂ by volume in the current lime production, as combustion-supporting air has to be fed to the fuel. The flue gas including vast CO₂ typically discharged to the atmosphere directly, causing pollution to the environment.

The lime kilns may be divided into the categories including multi-fuel kilns (i.e. solid fuels are the main fuel, including coke, coke powder, coal, etc.) and gas kilns (i.e. gas fuels are the main fuel, such as high-coke mixed gas, coke oven gas, converter gas, calcium carbide waste, producer gas, natural gas, etc.) based on fuel types. And the lime kilns may also be divided into categories including vertical kilns, rotary kilns, sleeve kilns, concurrent heat-accumulating double-chamber vertical kilns (also known as Melz kiln) and Falcas kilns (Italy) based on kiln types, among which annular sleeve kilns and Melz kilns are more widely used. The lime kilns may further be divided into categories including kilns operated under negative pressure, such as annular sleeve shaft kilns; and kilns operated under positive pressure (micro positive pressure), such as concurrent heat-accumulating double chamber shaft kilns, based on operation modes.

Lime kiln of any types may include a kiln body, an in-feeding device, a distributing device, a combustion device, an out-feeding, an electrical appliance, an instrument control device, a dedusting device and other components. The common characteristic of the lime kilns, especially of all kinds of gas kilns, is that the requirement of arrangement of a burning system. The burning system of a gas kiln is generally composed of burners configured with multiple rows and groups, and is arranged with gas fuel pipelines, combustion-supporting air pipelines, and nozzles, etc.

In order to more clearly explain the general characteristics of various forms of gas kiln, annular sleeve shaft kiln and concurrent heat-accumulating kiln (Maerz kiln), which are commonly used, will be taken as examples for detail description.

As shown in FIG. 1, the annular sleeve shaft kiln system includes: a furnace body 1, cooling air 1a, a feeding system 2, an upper inner sleeve 3-1, a heat exchanger 3-2, a lower inner sleeve 3-3, a waste gas discharging system 4, all waste gas 4a, a burner 5, gas fuel and nozzle air 5a, and a discharging system 6. The furnace body 1 is arranged with a preheating section 1-1, a calcining section 1-2, and a cooling section 1-3.

In the preheating section 1-1, limestone is heated to its calcination temperature. The heat of the preheating section 1-1 comes from the waste flue gas from the calcining section 1-2, and a part of the waste flue gas produced in the calcining section 1-2 goes upward to enter the preheating section 1-1, then is introduced into the waste gas system 4 from the upper part of the preheating section 1-1. Another part of the waste gas with excess heat is introduced into the heat exchanger 3-2 through the upper inner sleeve 3-1, and is used for heating combustion-supporting air, the heated combustion-supporting air is sent to the burner 5 through a pipeline and is discharged through the waste gas system 4 after exchanging heat.

The fuel gas mix with the combustion-supporting air to burn in the burner 5, and limestone is calcined in the calcining section 1-2. Part of the waste flue gas 4a generated in the calcining section 1-2 goes up to preheat the mineral material in the preheating section 1-1, and the finished lime enters the cooling section 1-3 from the bottom of the calcining section 1-2.

In the cooling section 1-3, the hot lime exchanges heat with the cold air 1a sucked from the kiln bottom, and the lime is discharged from the kiln body through the discharging system 6 after cooling. Cooling air 1a enters the kiln from the lower part of the cooling section 1-3 to mix with a part of waste flue gas of the burner 5 in the lower inner sleeve 3-3, and high-temperature waste air is obtained as a result. The high-temperature waste air is then discharged from the upper part of the lower inner sleeve 3-3 to enter the burner 5 to assist combustion.

Cylinder kilns have advantages including high thermal efficiency, large range of particle size of the raw materials entering the kiln, small occupied area, calcination under negative pressure, safe and stable operation, etc. The technical features of such furnace also include that the furnace defines a boundary region between the calcining section and the cooling section, the boundary region includes an operating area under a negative pressure and an operating area under a positive pressure. And, the concurrent flue gas is drawn out of the kiln body at the boundary region, part of all the waste flue gas is introduced into the heat exchanger through the inner cylinder, and the other part of all the waste flue gas is drawn out from the upper part of the kiln body after preheating the mineral material. Thereby, the operating area under negative pressure is formed in the upper part of the boundary region. Cooling air sucked from the bottom of the kiln body is pumped out of the upper part of the cooling section, thus forming the operating area under positive pressure in the lower part of the boundary belt.

In the above system, CO₂ generated by calcination in the kiln is discharged through the waste gas system 4. Recycling of CO₂ is expensive because the discharged gas includes air. The heat of the preheating section 1-1 and the calcining section 1-2 is provided by the high-temperature flue gas, which is generated by the combustion of gas fuel and combustion-supporting air in the burner 5. All the burners are arranged in two sections of the kiln body 1, and the raw materials are heated by the direct combustion, as a result, the heat cannot be evenly distributed. In this case, the whole calcination time is so long as to obtain high-quality lime, which not only requires larger kiln body but also greatly limits the productivity.

Concurrent heat-accumulating kiln (Maerz kiln) is also one of the kiln types widely used at present. At present, there are two types of lime shaft kilns, i.e. single-chamber counter-current and multi-chamber concurrent lime kilns (usually double-chamber). The standard concurrent heat-accumulating lime kiln is a double-chamber lime kiln with a combustion chamber and a non-combustion chamber, which work in turn. Generally, the concurrent heat-accumulating lime kiln is a circular double-chamber structure, the two chambers is connected by a channel and perform calcination at regular intervals. When one kiln chamber is calcined, combustion flue gas flows into the other kiln chamber from the combustion kiln chamber through the channel to preheat raw limestone. The concurrent heat-accumulating kiln has the advantages of high thermal efficiency, low energy consumption and high quality of lime products, but due to the addition of a reversing system, the equipment is more complex and costs more. Further, the yield of concurrent heat-accumulating kiln has not been significantly improved.

The working mechanisms of concurrent heat-accumulating kiln (Maerz kiln) and double-chamber lime shaft kiln are shown in FIG. 2, including: a combustion chamber 7, combustion air 7-1, a calcination section 7-2, a cooling section 7-3, an exhaust chamber 8, a preheating section 8-1, waste gas 8-2, a channel 9, a cooling section 8-3, and cooling air 10.

As mentioned above, with respective to widely used gas lime kilns in different forms, the preparing process and main parts of the apparatus used are basically similar to each other, although the structural form and calcination form of the lime kilns are different. The common problems of the gas lime kilns include the burners installed in the kiln bodies used for heating and calcining limestone, long calcination time, expensive apparatus, high operation and maintenance cost, low productivity, and “under-burning” or “over-burning”. Although significant improvements have been made, the above-mentioned common problems have not been completely solved.

The research results involving lime kilns include the follows.

A beam-type heat-accumulating lime kiln (CN 203007146 U), as shown in FIG. 3, includes: 1c—feed system, 2c—upper suction beam, 3c—preheating section, 6c—kiln body, 7c—lower suction beam, 8c—cooling section, 9c—discharge port, 10c—cyclone dust collecting device, 11c—bag dust collecting device, 12c—induced draft fan, 13c—second valve, 14c—second regenerator, 15c—nozzle, 16c—fourth valve, 17c—first valve, 18c—three-way valve, 19c—1 regenerator, 20c—third valve, 21c—combustion-supporting air, 22c—fuel, and 23c—discharge system.

According to the beam-type heat-accumulating lime kiln, hot waste gas is pumped out of the upper part of the cooling section of the kiln body for dedusting, the dedusted hot waste gas then enter the preheating device as combustion-supporting air. The combustion-supporting air preheating device consists of two heat-accumulating heat exchangers, which heat the combustion-supporting air in turn to continuously provide hot combustion-supporting air for the burner of the kiln body. Burners of the kiln body are arranged on the combustion beam of the kiln body. The heat-accumulating heat exchanger using gas with a low heating value as fuel has a main structure including a burner and a heat-accumulating chamber. The kiln burner may also apply gas with a low heating value providing that preheated combustion-supporting air is applied. The technology is characterized in that preheat the combustion-supporting air is preheated by the heat-accumulating heat exchanger to increase the temperature of the combustion-supporting air, allowing the burner of the kiln to apply gas with a low heating value. However, since the technology mentioned above only reduces the operation cost by applying gas with a low-heating value, and does not involve other common technical problems of the lime kilns applying gas fuel, the application of the technology is limited.

“AIR HEAT-ACCUMULATING LIME KILN (CN 203144298 U)” being similar to the above technology is technically characterized in that a “heat-accumulating nozzle” is designed on the burner of the kiln body, and combustion-supporting air is preheated by such nozzle containing heat-accumulating material to allow applying gas with a low heating value. Similarly, this technology does not involve other common technical problems of the lime kilns applying gas fuel.

A lime kiln technology “CONCURRENT HEAT-ACCUMULATING LIME KILN PRODUCTION TECHNOLOGY BASED ON CO₂ ACCUMULATION” (CN 105000811 A) is shown in FIG. 4.

The lime kiln includes: 1d—kiln chamber 1, 2d—kiln chamber 2, 3d—oxygen enrichment, 4d—CO₂ mixing with pulverized coal, 5d—CO₂ conveying pulverized coal as carrier gas, 6d—CO₂ heat exchange, purification device, 7d—CO₂ circulating gas, 8d—preheating section, 9d—calcining section, 10d—cooling section, 11d—cooled finished lime, 12d—recycled CO₂, and 13d—reversing device.

The technology is mainly characterized by adopting a concurrent heat-accumulating double kiln chambers, mixing 95% oxygen as combustion-supporting gas with solid pulverized coal injected into the calcining kiln chamber for combustion, conveying the solid pulverized coal by CO₂, cooling finished lime by CO₂ in a cooling section at the lower part of the kiln chamber, the flue gas generated during the calcination mixing with the high-temperature cooling gas at the upper part of the cooling section to enter the heat-accumulating kiln chamber through a passage of the double kiln chambers for preheating mineral materials, and rotating the calcining kiln chambers and the preheating kiln chamber through the reversing device at a certain interval. According to the technology, CO₂ with a concentration of more than 95% may be finally recycled. About 10% of the CO₂ is used for conveying solid fuel, about 55% of the CO₂ is used for cooling the finished lime, and about 35% of the CO₂ is recycled for making dry ice as an example.

Solid fuel-pulverized coal is applied as fuel in the technology. Although 95% oxygen is applied as combustion-supporting gas with an excess coefficient of 1.1˜1.4, the finished lime may still include a certain amount of fuel dust, which pollutes and reduce the quality of the finished product. In addition, according to the technology, “CO₂ is used as cooling gas to cool the CaO at temperatures of 1000-1150° C. to 80-100° C.”. According to the description of the technology, although three examples of 450 tons, 500 tons and 550 tons being produced per day are listed, the feasibility of adopting CO₂ as cooling gas is stilled in doubt. It is proved by the research results carried out by the inventor of the present application, and published research data that if CO₂ is used to cool high-temperature finished lime, part of the high-temperature finished lime may react with CO₂ to regenerate calcium carbonate, resulting in serious decrease of the quality of the finished lime.

For above, the above-mentioned researches cannot be widely applied due to reasons such as that the common technical problems of various gas kilns are not solved, solid fuel is applied, or CO₂ is applied as cooling gas.

### SUMMARY

Aiming at the problems existing in the prior art, the present application provides a lime kiln apparatus recycling CO₂ and a method for preparing industrial lime by applying the lime kiln apparatus.

The present application adopts the following technical solution.

The present application provides a lime kiln apparatus fully recycling CO₂, the lime kiln apparatus includes a kiln body (100) and a heat-accumulating furnace set (20), the kiln body (100) defines no burner, the heat-accumulating furnace set (20) is configured to heat CO₂ to a set temperature, and to send the heated CO₂ to the kiln body (100) to calcinate a preheated mineral material; wherein CO₂ generated during the calcination mixes with the CO₂ heated by the heat-accumulating furnace set (20) to go upwards to preheat a mineral material at an upper part of the kiln body (100), and the mixed CO₂ is pumped out of the upper part of the kiln body (100) to enter the heat-accumulating furnace set (20); the mixed CO₂ is sent to the kiln body (100) after being heated to the set temperature by the heat-accumulating furnace set (20); and finished lime obtained by the calcination is discharged from a bottom of the kiln body (100) after being cooled.

Optionally, the kiln body (100) includes a in-in-feeding device (30) and a out-in-feeding device (40); a working area of the kiln body (100) includes a preheating section (110), a calcining section (120) and a cooling section (130) sequentially arranged from top to bottom; wherein the mineral material is fed to the kiln body (100) from the in-feeding device (30), and sequentially passes the preheating section (110) and the calcining section (120); the finished lime is discharged from the out-feeding (40) after being cooled by the cooling section (130); a side wall of the calcining section (120) defines an inlet of the heated CO₂: a lower part of the cooling section (130) defines an inlet of cooling air (50); the cooling air (50) enters the kiln body (100) from the lower part of the cooling section (130) to cool the finished lime produced by the calcination, and the cooled finished lime is discharged out of the kiln body (100) through the out-feeding (40).

Optionally, the heat-accumulating furnace set (20) includes two or three furnaces, each of the furnaces applying a ceramic burner or a metal burner, and comprising a heat-accumulating chamber filled with a regenerator, wherein, on condition that the heat-accumulating furnace set (20) includes two furnaces, one of the two furnaces is configured to heat the regenerator with generated hot flue gas burnt by fuel with air, and the other furnace is configured to use the heated heat-accumulator to heat the CO₂; on condition that the heat-accumulating furnace set (20) includes three furnaces, two of the three furnaces are configured to generate the hot flue gas by burning the fuel with air to heat the regenerator, and the other furnace is configured to heat the CO₂.

Optionally, the kiln body (100) defines an inner cylinder (AB), a material passage for delivering material is formed between an inner wall of the kiln body (100) and an outer wall of the inner cylinder (AB), a total width of cross section of the material passage defines a passing diameter, the inner cylinder (AB) defines an air inlet at an upper part of the cooling section (130), the cooling air (50) enters the material passage from the lower part of the kiln body (100) to cool the finished lime, then enters the inner cylinder (AB) from the air inlet of the inner cylinder (AB), and is pumped out of the kiln body (100) from a top of the kiln body (100).

Optionally, the cooling air (50) forms a high-temperature waste cooling air during cooling the finished lime, and the high-temperature waste cooling air is pumped out of the kiln body (100) to enter a heat-accumulating heat exchanger of the heat-accumulating furnace set (20) for heating combustion-supporting air (22), wherein the heat-accumulating heat exchanger is a small heat-accumulating furnace without burner, and a dust collecting device is defined at a lower part of a heat accumulating chamber of the heat accumulating type heat exchanger.

Optionally, a steam inlet is defined in a side wall of the upper part of the cooling section (130) of the kiln body (100); on condition that the finished lime passes through the upper part of the cooling section (130) along the material passage, the finished lime is cooled for a first time by steam injected into the kiln body (100), the finished lime is cooled for a second time by cold CO₂, wherein the cold CO₂ is introduced into the cooling section (130) of the kiln body (100) from a bottom of the kiln body (100), goes upward to enter the calcining section (120) along with the steam, and is discharged out of the kiln body (100) from the top of the kiln body (100) together with the mixed CO₂, obtaining a CO₂ mixture which includes the steam; the CO₂ mixture is dedusted and dehydrated to obtain recycled CO₂, a part of the recycled CO₂ is introduced into a collecting device and the other part of the recycled CO₂ is introduced into the furnace set for reuse.

Optionally, an inner diameter of the kiln body (100) at the lower part of the preheating section (110) and the middle part of the calcining section (120) is larger than an inner diameter of the kiln body (100) at the lower part of the calcining section (120), and an inner diameter of the kiln body (100) at the cooling section (130) increases after a transition section of the kiln body (100).

Optionally, a ratio of a maximum passing diameter of the material passage at the middle of the calcining section (120) to a minimum passing diameter of the material passage at the lower part of the calcining section (120) ranges within 2-3.5, and a ratio of a maximum passing diameter of the material passage at the cooling section (130) to a diameter of the material passage at the transition section ranges within 2-3.5.

Optionally, the inner cylinder (AB) defines a dedusting device at a lower part of the inner cylinder (AB), the upper part of the inner cylinder (AB) is connected with an air guiding pipe, wherein the air guiding pipe is configured for pumping the high-temperature waste cooling air out of the upper part of the kiln body (100) to heat the combustion-supporting gas.

The present application also provides method for preparing industrial lime which totally recycles CO₂, characterized in that, the method includes: heating CO₂ to a set temperature; sending the heated CO₂ into a kiln body (100) to calcine preheated mineral material; obtaining mixed CO₂ by mixing CO₂ generated during the calcination of the mineral material mixes with the heated CO₂; preheating the mineral material at an upper part of the kiln body (100) by the mixed CO₂ going upward; pumping the mixed CO₂ out of the upper part of the kiln body (100) to obtain recycled CO₂; sending a part of the recycled CO₂ to a furnace set; heating the recycled CO₂ to a set temperature and then sending back the heated recycled CO₂ to the kiln body (100); and discharging finished lime produced by the calcination from a bottom of the kiln body (100) after the finished lime is cooled by air.

The present application has the following technical effects.

1. The lime kiln uses hot CO₂ to calcine mineral materials, the hot CO₂ having an adjustable constant temperature and no flame. By accurately controlling the temperature of the CO₂, the over-burning is eliminated, which is beneficial to the product activity. Thereby, the calcination effect is improved. Using CO₂ as a carrier of heat for calcining mineral material substantially reduces the calcination time, that is, the productivity may be greatly improved without increase of the kiln volume. This effect is demonstrated by the inventor of the present application in a way of an experiment. It is proved that Using CO₂ as a carrier of heat for calcining mineral material may not only greatly reduce the calcination time but also obtain finished lime with high quality and activity.

2. Burners in the kiln are eliminated, which substantially simplifies the kiln structure, makes the system more stable and reliable, facilitates maintenance, and reduces the maintenance cost of the system.

3. On the one hand, reduction of CO₂ emission is realized; on the other hand, a byproduct with high added value is provided for the lime kiln system, increasing the economic benefit of the present application.

4. The heat-accumulating furnace may use blast furnace gas with a lower heating value as fuel to continuously provide heat for lime kiln, expensive coke oven gas, converter gas or other fuel with a high heating value are replaced. By cancelling the burners inside the kiln, the kiln structure is simplified according to the present application. Compared with the current various lime kilns, the present application greatly reduces the operation cost of the lime kiln.

### BRIEF DESCRIPTION OF THE DRAWINGS

The present application will be further described with reference to the accompanying drawings.

FIG. 1 is a schematic structural diagram of an annular sleeve shaft kiln system in the prior art;

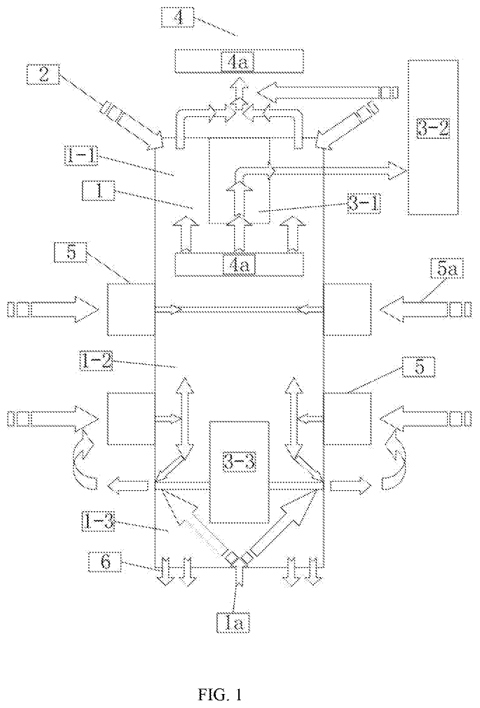

FIG. 2 is a schematic structural diagram of a concurrent heat-accumulating (Maerz kiln) and double-chamber lime shaft kiln in prior art;

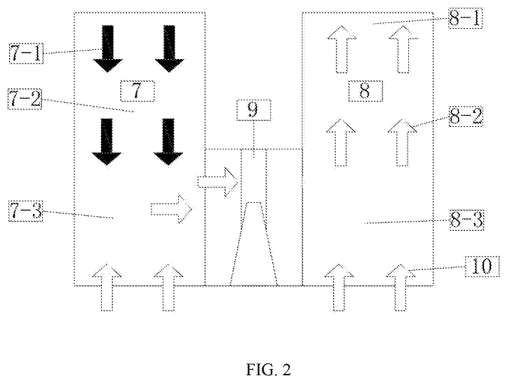

FIG. 3 is a schematic structural diagram of a beam-type heat-accumulating lime kiln in prior art;

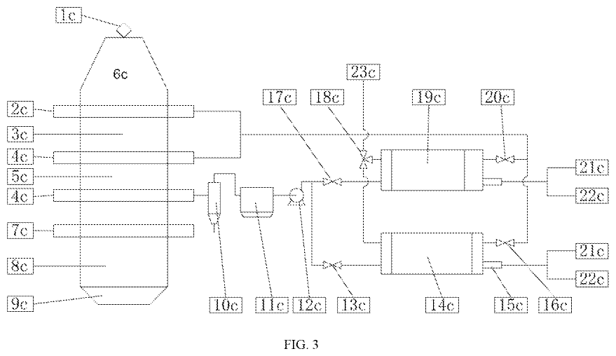

FIG. 4 is a schematic structural diagram of a concurrent heat-accumulating lime kiln in prior art:

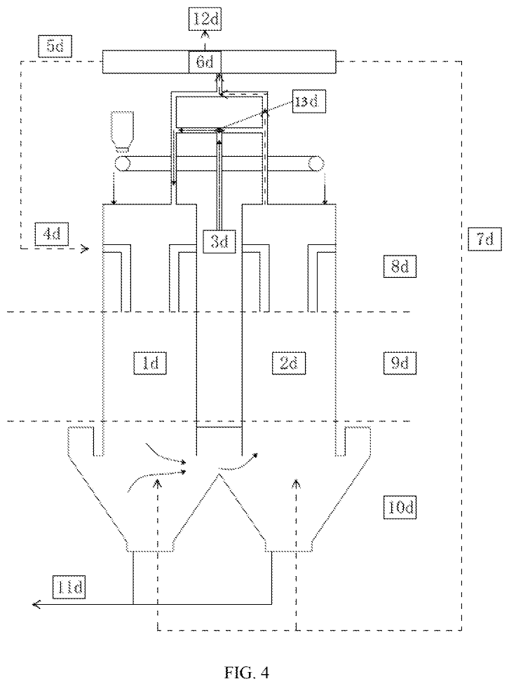

FIG. 5 is a structural diagram of a lime kiln apparatus in example 1 of the present application;

FIG. 6 is a schematic diagram of the working principle of the lime kiln apparatus in example 1 of the present application;

FIG. 7 is a schematic diagram of the working principle of the heat-accumulating furnace in example 1 of the present application.

### DETAILED DESCRIPTION OF THE EMBODIMENTS

The present application will be further described below with reference to the accompanying drawings and detailed description.

### Example 1

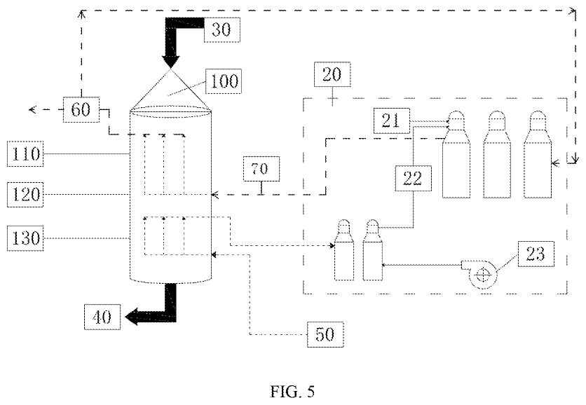

FIG. 5 shows the structure and working principle of a lime kiln system fully recycling CO₂, which includes: 100—kiln body, 20—furnace set, 21—blast furnace gas, 22—combustion-supporting air, 23—combustion fan, 30—in-in-feeding device, 40—out-feeding, 50—cooling air, 60—CO₂ recycling device, and 70—hot CO₂. The kiln body 100 includes a preheating section 110, a calcining section 120, and a cooling section 130.

As shown in FIG. 5, all current lime kiln technologies using gas fuel being compared, according to the lime kiln apparatus of the present application, hot CO₂ having a constant temperature and no flame is used as a heat carrier to calcine mineral materials, which accelerates the decomposition of the mineral materials. Thereby, finished lime with a high quality may be obtained, and the calcination time is significantly reduced by using the lime kiln apparatus of the present application.

The mineral material enters the kiln body 100 from the in-in-feeding device 30, sequentially passes through the preheating section 110, the calcining section 120 and the cooling section 130, and the cooled finished lime is discharged from the lower out-feeding 40 of the kiln body 100. The mineral material is preheated and calcined by hot CO₂, and the finished lime obtained by calcination is cooled by air.

The preheated mineral material is calcined by the hot CO₂ entering the kiln body from the calcining section, then the hot CO₂ combined with CO₂ generated by decomposition of the mineral material goes up to enter the preheating section 110 at the upper part of the kiln body 100, and is pumped out of the upper part of the kiln body 100 after cooling down. The CO₂ pumped out is introduced into the CO₂ recycling device 60, and after the CO₂ pumped out is dedusted, one part of the dedusted CO₂ is recycled, the other part of the dedusted CO₂ is introduced into the heat-accumulating furnace set to be heated and then returns to the calcining section 120 of the kiln body 100.

Preferably, the furnace set 20 consists of two heat-accumulating furnaces or three heat-accumulating furnaces. The furnace set 20 uses fuel such as blast furnace gas 21, coal powder, coal water slurry, natural gas or other gaseous fuels to heat the CO₂ from the kiln body to a required temperature according to the process. The temperature is generally within a range of 800° C.-1250° C., and the preferred range is 850° C.-1150° C.

The finished lime obtained by the calcination enters the cooling section 130, and the cooling air 50 enters the cooling section 130 of the kiln body 100 from the lower part of the kiln body 100 to cool the finished lime. The cooled finished lime is then drawn out from the upper part of the cooling section 130 of the kiln body 100 and fed into the furnace set 20. The waste heat generated by the cooling air 50 during cooling the finished lime is used to heat the combustion-supporting air 22 via the heat-accumulating heat exchanger (two heat exchanger work alternately) in the furnace set 20.

The utilization of the waste heat generated by the cooling air 50 during cooling the finished lime may be realized by other mature process technologies in the field, such as heat exchangers made of materials resisting high temperature, or may be used for power generation by waste heat, in addition to the above-mentioned heat-accumulating heat exchangers.

For those auxiliary facilities and equipment not shown in FIG. 5 that are not related to the present application, it does not mean that these auxiliary facilities and equipment are not necessary for the realization of the present application. In order to realize the purpose of the present application, it is requested to configure necessary auxiliary facilities and equipment with mature technologies.

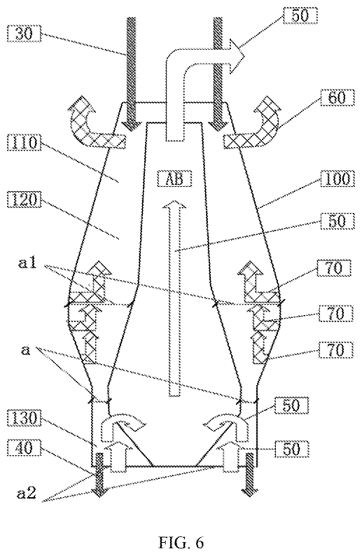

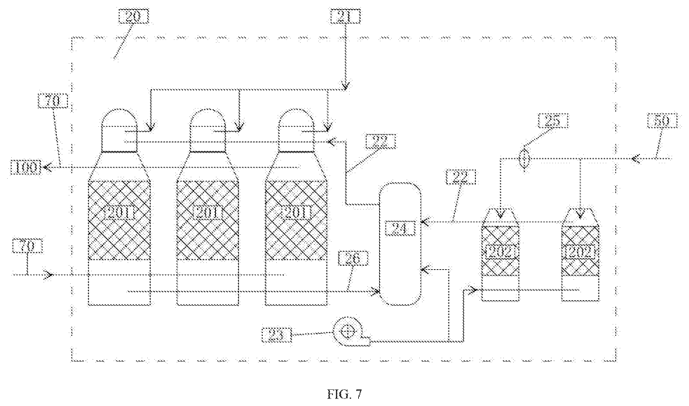

In order to explain the implementation method of the present application more clearly, FIGS. 6 and 7 further explain the working principles of the lime kiln and the heat-accumulating furnace set. FIG. 6 is a schematic diagram of the working principle of the lime kiln involved in the example, which illustrates the method of recycling CO₂ from the lime kiln and calcining mineral materials by hot CO₂. FIG. 7 is a schematic diagram of the working principle of the heat-accumulating furnace involve in the example of the present application, which illustrates the method of using the heat-accumulating fuel group to heat CO₂ by using fuel with a low heating value and to heat combustion-supporting air by using the waste heat of cooling air.

According to FIG. 5, in terms of the kiln body of the lime kiln system, one of the keys to realize the present application is related to the technology of separating CO₂ at the upper part of the kiln body from the cooling air at the lower part of the kiln body, and the technologies of dusting and waste heat utilization.

FIG. 6 is a typical example in which the lime kiln apparatus of the present application has a relatively simple structure and may effectively reduce CO₂ emission.

The lime kiln apparatus includes: lime kiln body 100, inner cylinder AB, preheating section 110, calcining section 120, cooling section 130, in-feeding device 30, out-feeding 40, cooling air 50, CO₂ recycling device 60, and hot CO₂ 70.

According to FIG. 6, the kiln body 100 is defined with an inner cylinder AB, and a material passage for delivering material is formed between the inner wall of the kiln body 100 and the outer wall of the inner cylinder AB. The material passage has different passing diameter at the preheating section, the calcining section and the cooling section. Mineral material enters the kiln body 100 from the top by the feeding system 30, passes through the preheating section 110 and the calcining section 120 along the material passage between the inner wall of the kiln body and the outer wall of the inner cylinder AB, and the finished product enters the cooling section 130. finally, the cooled finished lime is discharged through the discharging system 40.

The hot CO₂ 70 enters the kiln body 100 through three rows of air inlet nozzles arranged on the kiln body 100. Under the calcining section 120, a transition section is formed between the calcining section 120 and the cooling section 130, the material passage narrowing at the transition section. The transition section defines a “material sealing layer” between the calcining section and the cooling section. The main function of the “material sealing layer” of the transition section is to prevent the cooling air 50 from entering the calcining section 120.

In order to achieve the above purpose, the typical solution provided by the present application is as follows.

The kiln body 100 is in the form of a circular shaft kiln, preferably, is a drum waist shaft kiln with a larger inner diameter at the lower part of the preheating section 110 and the middle part of the calcining section 12, and a smaller inner diameter at the lower part of the calcining section 120. The kiln body 100 defines an inner cylinder AB therein, which is commonly in the form of a circular cylinder or a special-shaped cylinder. A material passage for delivering material is formed between the inner wall of the kiln body 100 and the outer wall of the inner cylinder AB. The total width of the cross section of the material passage defines a passing diameter. The passing diameter of the material passage is different in the preheating section, the calcining section and the cooling section. The passing diameter of the material passage in the middle of the calcining section 120 is larger, such as “a1”. The material passage has a transition section between the calcining section and the cooling section, and the passing diameter of the transition section is smaller, such as “a”. The ratio of the largest passing diameter of the material passage at the middle of the calcining section 120 to the smallest passing diameter at the lower part of the calcining section is within a range of 1-4, and preferably, 2-3.5.

Since the transition section of the material passage located at the lower part of the calcining section 120 has a smaller passing diameter, the material moves faster in the transition section with the smaller passing diameter, thus forming the “material sealing layer” of the transition section. Such structure may not only prevent the cooling air from entering the calcining section 120, but also is beneficial for improving the activity of the finished lime.

The finished lime is cooled by using cooling air. The typical solution provided by the present application is as follow.

An inner cylinder AB is defined inside the kiln body 100, a dedusting device is defined inside the inner cylinder AB, a dust collecting device is defined at the lower part of the inner cylinder AB, and the upper part of the inner cylinder AB is connected with an air guiding pipe, the air guide pipe is configured for pumping the high-temperature cooling air 50 out of the upper part of the kiln body 100, and an air inlet is defined in the inner cylinder AB at the upper part of the cooling section 130. The cooling air 50 enters the material passage at the lower part of the cooling section 130, that is, the lower part of the kiln body 100, and is drawn into the inner cylinder AB through the air inlet of the inner cylinder AB at the upper part of the cooling section 130.

In the cooling section 130, the finished lime moves downward along the material passage, while the cooling air 50 flows inversely upward to cool the lime product. The passing diameter of the material passage at the middle and lower parts of the cooling section is larger, such as a2, and the ratio of the maximum passing diameter a2 of the material passage at the cooling section to the minimum passing diameter a of the material passage at the transition section above the cooling section is within a range of 1-4, preferably, 2-3.5. The finished lime enters the out-feeding 40 after being cooled. Under the suction by the air guiding pipe, the inner cylinder AB acquires negative pressure inside, and cooling air 50 is drawn into the inner cylinder AB from the air inlet at the upper part of the cooling section 130. After being dedusted by the inner cylinder AB, the cooling air 50 is drawn out of the kiln body 100 via the air guiding pipe.

In order to achieve the above objectives, other solutions different from the above typical solutions may also be adopted, but no matter which solution, efforts should be made to achieve 1) the cooling air being prevented from entering the calcining section; 2) the high-temperature cooling air being pumped out of the kiln body after preliminary dedusting.

FIG. 7 is a schematic diagram of the working principle of the heat-accumulating furnace set 20 according to the present application. The heat-accumulating furnace set 20 includes a heat-accumulating furnace 201, a heat-accumulating heat exchanger 202, a blast furnace gas 21, combustion-supporting air 22, a combustion fan 23, an air mixing chamber 24, a heat-accumulating heat exchanger reversing device 25, and heat-accumulating furnace flue gas 26.

And, three heat-accumulating furnaces 201 are preferably used to ensure continuous hot air supply to the lime kiln system. When one furnace is under maintenance, the other two furnaces may also keep the production.

The three heat-accumulating furnaces adopt the working mode of “two burning and one delivery”. The heat-accumulating furnace 201 uses blast furnace gas 21 and combustion-supporting air 22 when burning in the furnace. The cold dedusted CO₂ collected from the lime kiln system is heated to 800° C.-1200° C. by the furnace 201, and then is sent back to the lime kiln 100 through the hot air nozzles annularly arranged.

The working principle of the furnace 201 is as follows. During one furnace burning period, blast furnace gas 21 and combustion-supporting air 22 enter the burner of the heat-accumulating furnace 201 for combustion to generate high-temperature flue gas of 1100° C.-1300° C., the flue gas is used for heat heat-accumulating materials in the furnace. During one air supply period, the burner is turned off, and cold CO₂ is introduced which is a part of the CO₂ collected and dedusted by the lime kiln 100. The CO₂ is heated by the heat-accumulating materials of the furnace 201, and is sent back to the lime kiln 100 at a constant temperature within the range of 800° C.-1200° C. through the hot air nozzles annularly arranged. The furnace set has a working mode of “two burning and one sending”, i.e. two furnaces are configured for burning and one furnace is configured for supplying air at the same time.

A dust collecting device is defined at the lower part of the furnace 201 for collecting dust and convenience of cleaning the furnace during routine maintenance.

The waste flue gas of the furnace 201 generally needs to be continuously cooled, dedusted and discharged. There are many alternative technical solutions to cool the waste flue gas of the furnace 201. The preferred technical solution of the present application is to introduce the waste flue gas of the furnace 201 to the air mixing chamber 24 to adjust the temperature of combustion-supporting air from the heat-accumulating heat exchanger 202.

The shells of the two heat-accumulating heat exchangers 202 are made of metal structural steel and are provided with thermal insulation linings, the upper part of each heat-accumulating heat exchangers 202 is defined in an arched structure, the lower part of each heat-accumulating heat exchangers 202 is provided with a heat-accumulating chamber with heat-accumulating material defined inside, the heat-accumulating material is preferably in the form of checker bricks, a heat-resistant cast iron supporting device or a supporting structure made of refractory materials is defined at the lower part of the checker bricks. A waste gas outlet and a combustion-supporting air inlet are defined at the lower part of the heat-accumulating heat exchanger 202, a combustion-supporting air outlet is defined at the upper part of the checker bricks, and a dust collecting device is defined at the bottom of the heat-accumulating heat exchanger 202, an air inlet for high-temperature cooling air 50 is defined at the arched upper part, and the high-temperature cooling air 50 from the kiln body 100 enters the heat exchanger 202 from the arched upper part of the heat-accumulating heat exchanger 202 through an air guiding pipe.

The high-temperature cooling air 50 from the kiln body 100 is introduced into the heat exchanger from the arched top of a first heat-accumulating heat exchanger 202 through a pipeline to heat the heat-accumulating materials of the heat-accumulating chamber, and is discharged from the waste gas outlet after being cooled down, finally is emitted after being dedusted.

After the heat-accumulating material of the first heat exchanger is heated to a preset temperature, that is, after a cycle of “heating” is completed, the high-temperature cooling air 50 is introduced into a second heat-accumulating heat exchanger 202 through a pipeline by switching a valve to heat the heat-accumulating materials in the heat-accumulating chamber of the second heat exchanger. And, cold combustion-supporting air 22 is introduced into the first heat-accumulating heat exchanger 202 from the lower part and is discharged above the heat-accumulating material after being heated by the heat-accumulating materials in the heat-accumulating chamber to enter the air mixing chamber 24. The air mixing chamber is also introduced with cold combustion-supporting air and waste flue gas from the furnace 201 for adjusting the temperature of the combustion-supporting air 22. The combustion-supporting air 22 is introduced into the heat-accumulating furnace 201 from the air mixing chamber 24 at a constant temperature.

A small amount of dust carried by the high-temperature cooling air 50 is collected by a collecting device at the lower part of the heat exchanger 202, and is cleaned out of the heat-accumulating heat exchanger during routine maintenance.

The present application also provides a method for cooling the finished lime in the kiln, including the following operations: defining a steam inlet in the side wall of the upper part of the cooling section of the kiln body; spraying steam into the kiln to cool the finished lime for a first time, when the finished lime passes through the upper part of the cooling section along a material passage; cooling the finished lime for a second time by using cold CO₂, wherein the cold CO₂ is introduced into the cooling section of the kiln body from the bottom of the kiln, then goes upward with the steam to enter the calcining section, the steam and the cold CO₂ mix with CO₂ generated by the calcination to obtain CO₂ mixture; discharging the CO₂ mixture out of the kiln body from the top of the kiln; dedusting and dehydrating the CO₂ mixture to obtain recycled CO₂, part of the recycled CO₂ being introduced a collecting device, and the other part of the recycled CO₂ being introduced to the furnace set as circulating air.

For those skilled in the technical field, the inventive concept may be realized in different ways with the technology development. The embodiments of the present application are not limited to the examples described above, but may be varied within the scope of the claims.

What is claimed is:

1. A lime kiln apparatus fully recycling CO₂, wherein comprising a kiln body (100) and a heat-accumulating furnace set (20), the kiln body (100) defines no burner, the heat-accumulating furnace set (20) is configured to heat CO₂ to a set temperature, and to send the heated CO₂ to the kiln body (100) to calcinate a preheated mineral material; wherein CO₂ generated during the calcination mixes with the CO₂ heated by the heat-accumulating furnace set (20) to go upwards to preheat a mineral material at an upper part of the kiln body (100), and the mixed CO₂ is pumped out of the upper part of the kiln body (100) to enter the heat-accumulating furnace set (20); the mixed CO₂ is sent to the kiln body (100) after being heated to the set temperature by the heat-accumulating furnace set (20); and finished lime obtained by the calcination is discharged from a bottom of the kiln body (100) after being cooled.

2. The lime kiln apparatus fully recycling CO₂ according to claim 1, wherein the kiln body (100) comprises a in-in-feeding device (30) and a out-in-feeding device (40); a working area of the kiln body (100) comprises a preheating section (110), a calcining section (120) and a cooling section (130) sequentially arranged from top to bottom; wherein the mineral material is fed to the kiln body (100) from the in-feeding device (30), and sequentially passes the preheating section (110) and the calcining section (120): the finished lime is discharged from the out-feeding (40) after being cooled by the cooling section (130); a side wall of the calcining section (120) defines an inlet of the heated CO₂; a lower part of the cooling section (130) defines an inlet of cooling air (50); the cooling air (50) enters the kiln body (100) from the lower part of the cooling section (130) to cool the finished lime produced by the calcination, and the cooled finished lime is discharged out of the kiln body (100) through the out-feeding (40).

3. The lime kiln apparatus fully recycling CO₂ according to claim 1, wherein the heat-accumulating furnace set (20) comprises two or three furnaces, each of the furnaces applying a ceramic burner or a metal burner, and comprising a heat-accumulating chamber filled with a regenerator, wherein, on condition that the heat-accumulating furnace set (20) comprises two furnaces, one of the two furnaces is configured to heat the regenerator with generated hot flue gas burnt by fuel with air, and the other furnace is configured to use the heated heat-accumulator to heat the CO₂; on condition that the heat-accumulating furnace set (20) comprises three furnaces, two of the three furnaces are configured to generate the hot flue gas by burning the fuel with air to heat the regenerator, and the other furnace is configured to heat the CO₂.

4. The lime kiln apparatus fully recycling CO₂ according to claim 2, wherein the kiln body (100) defines an inner cylinder (AB), a material passage for delivering material is formed between an inner wall of the kiln body (100) and an outer wall of the inner cylinder (AB), a total width of cross section of the material passage defines a passing diameter, the inner cylinder (AB) defines an air inlet at an upper part of the cooling section (130), the cooling air (50) enters the material passage from the lower part of the kiln body (100) to cool the finished lime, then enters the inner cylinder (AB) from the air inlet of the inner cylinder (AB), and is pumped out of the kiln body (100) from a top of the kiln body (100).

5. The lime kiln apparatus fully recycling CO₂ according to claim 4, wherein the cooling air (50) forms a high-temperature waste cooling air during cooling the finished lime, and the high-temperature waste cooling air is pumped out of the kiln body (100) to enter a heat-accumulating heat exchanger of the heat-accumulating furnace set (20) for heating combustion-supporting air (22), wherein the heat-accumulating heat exchanger is a small heat-accumulating furnace without burner, and a dust collecting device is defined at a lower part of a heat accumulating chamber of the heat accumulating type heat exchanger.

6. The lime kiln apparatus fully recycling CO₂ according to claim 2, wherein a steam inlet is defined in a side wall of the upper part of the cooling section (130) of the kiln body (100); on condition that the finished lime passes through the upper part of the cooling section (130) along the material passage, the finished lime is cooled for a first time by steam injected into the kiln body (100), the finished lime is cooled for a second time by cold CO₂, wherein the cold CO₂ is introduced into the cooling section (130) of the kiln body (100) from a bottom of the kiln body (100), goes upward to enter the calcining section (120) along with the steam, and is discharged out of the kiln body (100) from the top of the kiln body (100) together with the mixed CO₂, obtaining a CO₂ mixture which comprises the steam; the CO₂ mixture is dedusted and dehydrated to obtain recycled CO₂, a part of the recycled CO₂ is introduced into a collecting device and the other part of the recycled CO₂ is introduced into the furnace set for reuse.

7. The lime kiln apparatus fully recycling CO₂ according to claim 2, wherein an inner diameter of the kiln body (100) at the lower part of the preheating section (110) and the middle part of the calcining section (120) is larger than an inner diameter of the kiln body (100) at the lower part of the calcining section (120), and an inner diameter of the kiln body (100) at the cooling section (130) increases after a transition section of the kiln body (100).

8. The lime kiln apparatus fully recycling CO₂ according to claim 4, wherein a ratio of a maximum passing diameter of the material passage at the middle of the calcining section (120) to a minimum passing diameter of the material passage at the lower part of the calcining section (120) ranges within 2-3.5, and a ratio of a maximum passing diameter of the material passage at the cooling section (130) to a passing diameter of the material passage at the transition section ranges within 2-3.5.

9. The lime kiln apparatus fully recycling CO₂ according to claim 4, wherein the inner cylinder (AB) defines a dedusting device at a lower part of the inner cylinder (AB), the upper part of the inner cylinder (AB) is connected with an air guiding pipe, wherein the air guiding pipe is configured for pumping the high-temperature waste cooling air out of the upper part of the kiln body (100) to heat the combustion-supporting gas.

10. A method for preparing industrial lime which totally recycles CO₂, wherein the method comprises:
heating CO₂ to a set temperature; sending the heated CO₂ into a kiln body (100) to calcine preheated mineral material;
obtaining mixed CO₂ by mixing CO₂ generated during the calcination of the mineral material mixes with the heated CO₂;
preheating the mineral material at an upper part of the kiln body (100) by the mixed CO₂ going upward;
pumping the mixed CO₂ out of the upper part of the kiln body (100) to obtain recycled CO₂;
sending a part of the recycled CO₂ to a furnace set; heating the recycled CO₂ to a set temperature and then sending back the heated recycled CO₂ to the kiln body (100); and
discharging finished lime produced by the calcination from a bottom of the kiln body (100) after the finished lime is cooled by air.
